(19) United States
(12) Patent Application Publication
(10) Pub. No.: US 2004/0259451 A1
(43) Pub. Date: Dec. 23, 2004

(54) Blended fiber materials, methods of manufacture and uses thereof

(76) Inventors: David P. Paradis, Waleska, GA (US); Charlie E. Bowers, Hopewell, VA (US)

Correspondence Address: RIORDAN & MCKINZIE, 300 SOUTH GRAND AVENUE, 29TH FLOOR, LOS ANGELES, CA, 90071, US

(21) Appl. No.: 10/602,459

(22) Filed: Jun. 23, 2003

(51) Int. Cl. B32B 5/26; D04H 1/00; D03D 13/00

(52) U.S. Cl. 442/381; 442/389; 442/415; 442/409; 442/414

(57) ABSTRACT

A fiber material is described herein that includes: a) a first base fiber component comprising a first denier and a first luster component; b) a second base fiber component comprising a second denier and a second luster component, wherein the first denier and the second denier are different and wherein the first luster component and the second luster component are different; and c) a plurality of binder fibers. In addition, methods are provided herein that teach that a fiber material may be produced that includes: a) providing a first base fiber component comprising a first denier and a first luster component; b) providing a second base fiber component comprising a second denier and a second luster component, wherein the first denier and the second denier are different and wherein the first luster component and the second luster component are different; c) providing a plurality of binder fibers; and d) blending the first base fiber component, the second base fiber component and at least some of the plurality of binder fibers to form the fiber material. In some methods, an energy source is used to activate and/or form a bond between the plurality of binder fibers and at least one of the first base fiber component and the second base fiber component, wherein the energy source is a heat source, such as an atmospheric pressure forced air machine, which can be followed by a steam purge, or a pressurized twist-setting machine. Yarn products and carpet products may also be produced using the fiber materials formed herein.

### FIELD OF THE SUBJECT MATTER

The field of the subject matter herein is fiber materials, yarn products and carpet products, methods of manufacture and uses thereof, and more specifically, blended fiber materials, methods of manufacture and uses thereof.

### BACKGROUND

Fibers for consumer use, especially fibers that are incorporated into carpet products and fabrics/textiles, are constantly being evaluated for improvements with respect to the consumer's sensory perception. These improvements may relate to texture, quality, softness and luster.

Carpet fibers, which are used in the production of carpet products, such as wall-to-wall carpet, rugs and mats, are modified and in some instances improved to provide a certain fiber texture, overall texture when the fibers are incorporated into a carpet product and to provide a desired “look” for the space where the carpet product is being used. Additional issues that arise in the design of carpet fiber material and carpet products are daily and long-term durability.

One method that is being used to modify the texture of fabrics is to incorporate fibers that have mixed deniers into the fabric product. Denier (or fiber denier) is a physical property of a particular fiber and can be defined as: “A direct yarn numbering measurement, it is the weight in grams of 9,000 meters of yarn. Therefore, the higher the denier, the larger the yarn. Typical nylon carpet fiber has 15-18 denier. This thickness of a fiber can be regulated by the size of the openings of the spinneret.” (see www.fabrica.com: Glossary of Fabric and Rug Terms)

PCT Application Publication No.: WO 9950484 discloses that the comfort properties of copolyester fibers can be improved by combining fibers having two different deniers. Japanese Publication No.: JP 01250426 discloses that mixed denier polyester fibers can be used to produce a blended yarn suitable for incorporating into fabrics in order to give a “soft feeling”. Japanese Publication No.: JP 02099631 discloses that mixed denier yarns can be produced for fabrics that have a “silky” touch and that are suitable for producing fabrics, such as those used to make ladies' blouses.

Mixed denier fibers are also being incorporated into textiles that are used as carpet “backings” (see U.S. Pat. No. 6,506,873). In addition, mixed denier fibers are utilized in producing abrasive materials and articles, where some of the individual fibers come from recycled carpet fibers, but the carpet fibers themselves are not mixed denier blends or yarns. (see U.S. Pat. Nos.: 6,352,567; 6,017,831; 5,919,549 and 5,863,305)

Luster is another characteristic of a fiber and/or yarn. Luster can be defined as follows: “brightness or reflectivity of fibers, yarns, carpets or fabrics. Synthetic fibers are produced in various luster classifications including bright, semi-bright, semi-dull and mid-dull. The luster of finished carpet could also be influenced by yarn heatsetting methods, dyeing and finishing. In high-traffic commercial areas, duller carpet yarns are often preferred for soil-hiding ability.” (see www.fabrica.com: Glossary of Fabric and Rug Terms) Luster levels are considered when producing fibers and yarn; however, generally fiber and yarn blends are put together using a single luster level to produce a desired effect on the look of the finished product.

Therefore, it would be desirable to produce a fiber material and/or yarn that combines a mixed dernier and mixed luster levels, which can be incorporated into the production of a new and unique carpet product.

### SUMMARY OF THE SUBJECT MATTER

A fiber material is described herein that includes: a) a first base fiber component comprising a first denier and a first luster component; b) a second base fiber component comprising a second denier and a second luster component, wherein the first denier and the second denier are different and wherein the first luster component and the second luster component are different; and c) a plurality of binder fibers.

In addition, methods are provided herein that teach that a fiber material may be produced that includes: a) providing a first base fiber component comprising a first denier and a first luster component; b) providing a second base fiber component comprising a second denier and a second luster component, wherein the first denier and the second denier are different and wherein the first luster component and the second luster component are different; c) providing a plurality of binder fibers; and d) blending the first base fiber, the second base fiber and at least some of the plurality of binder fibers to form the fiber material.

### DETAILED DESCRIPTION

In order to produce a fiber material and/or yarn that combines a mixed dernier and mixed luster levels, which can be incorporated into the production of a new and unique carpet product, a fiber material has been developed that includes: a) a first base fiber component comprising a first denier and a first luster component; b) a second base fiber component comprising a second denier and a second luster component, wherein the first denier and the second denier are different and wherein the first luster component and the second luster component are different; and a plurality of binder fibers.

At this point it should be understood that, unless otherwise indicated, all numbers expressing quantities of ingredients, constituents, interaction conditions and so forth used in the specification and claims are to be understood as being modified in all instances by the term “about”. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical value, however, inherently contain certain errors necessarily resulting from the standard deviation found in their respective testing measurements.

In a contemplated embodiment, the first base fiber component and/or the second base fiber component may comprise any suitable base fiber material. In other contemplated embodiments, the first base fiber component and/or the second base fiber component comprise materials previously disclosed in European Patent No. 324,773 and U.S. Pat. No. 5,478,624, which are both commonly-owned and incorporated herein by reference in their entirety. As mentioned in those patents, the first base fiber component and/or the second base fiber component may comprise a polyamide-based compound, including nylon-6 and nylon-6,6 or a polyester-based compound.

The first base fiber component comprises a first denier and a first luster component. The second base fiber component comprises a second denier and a second luster component. As mentioned earlier, denier (or fiber denier) is a physical property of a particular fiber and can be defined as: “A direct yarn numbering measurement, it is the weight in grams of 9,000 meters of yarn. Therefore, the higher the denier, the larger the yarn. Typical nylon carpet fiber has 15-18 denier. This thickness of a fiber can be regulated by the size of the openings of the spinneret.” (see www.fabrica.com: Glossary of Fabric and Rug Terms) Contemplated deniers range from about 6 to about 12. In a contemplated embodiment, the first and second deniers are less than about 12. In yet other embodiments, the first and second deniers are less than about 10.

The first denier and the second denier comprise any suitable denier for the needs of the product, the customer and/or the vendor, and each of the first denier and the second denier are different from one another. For example, the first denier may be 6.5 and the second denier may be 10. It should be understood that regardless of the size of the first denier and the second denier, each is intentionally selected such that the first denier differs in size from the second denier. In other words, the first denier and the second denier are not equal to one another.

The first luster component and the second luster component comprise any suitable luster depending on the needs of the product, the customer and/or the vendor, and each of the first luster component and the second luster component are different from one another. Each luster component may be determined by any suitable and conventional method, but luster components are referred to herein as by their percent TiO₂, % TiO₂ or their percent titanium dioxide content, which are each interchangeable and have the same meaning for the purposes of this work. In contemplated embodiments, the first luster component may comprise a luster of less than about 0.45% TiO₂. In other contemplated embodiments, the first luster component may comprise a luster of less than about 0.25% TiO₂. In yet other contemplated embodiments, the first luster component may comprise a luster of less than about 0.15% TiO₂. In additional contemplated embodiments, the first luster component may comprise a luster of less than about 0.1% TiO₂. In contemplated embodiments, the second luster component may comprise a luster of less than about 0.45% TiO₂. In other contemplated embodiments, the second luster component may comprise a luster of less than about 0.25% TiO₂. In yet other contemplated embodiments, the second luster component may comprise a luster of less than about 0.15% TiO₂. In additional contemplated embodiments, the second luster component may comprise a luster of less than about 0.1% O₂. It should be understood; however, that the first luster component and the second luster component are intentionally selected to be different from one another. In other words, the first luster component and the second luster component are not equal to one another.

As described herein, a plurality of binder fibers are contemplated and may comprise any suitable binder fiber material depending on the needs of the product, customer and/or the vendor. As contemplated herein, at least some of the plurality of binder fibers may comprise a synthetic material. As further contemplated, the synthetic material may comprise at least one heat-active material and also may comprise at least one polyamide compound or polyamide-based compound. As used herein, the term “compound” means a substance with constant composition that can be broken down into elements by chemical processes. Polyamides and polyamide-based compounds, as the name implies, are polymers that comprise amide monomers. Several contemplated polyamide-based compounds comprise nylon-6, nylon-6,6 and/or nylon-12.

Amides are an important group of nitrogenous compounds and monomers that are used as intermediates and/or building blocks in the production of polymers, textiles, plastics and adhesives. Aimide monomers are generally represented by the following formula:

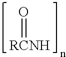

wherein R is an alkyl group, an aryl group, a cyclic alkyl group, an alkenyl group, an arylalkylene group, or any other appropriate group that can be utilized to be a part of an amide compound.

As used herein, the term “monomer” generally refers to any chemical compound that is capable of forming a covalent bond with itself or a chemically different compound in a repetitive manner. The repetitive bond formation between monomers may lead to a linear, branched, super-branched, or three-dimensional product. Furthermore, monomers may themselves comprise repetitive building blocks, and when polymerized the polymers formed from such monomers are then termed “blockpolymers”. The weight-average molecular weight of monomers may vary greatly between about 40 Dalton and 20000 Dalton. However, especially when monomers comprise repetitive building blocks, monomers may have even higher molecular weights. Monomers may also include additional groups, such as groups used for crosslinking, radiolabeling, and/or chemical or environmental protecting.

The term “alkyl” is used herein to mean a branched or a straight-chain saturated hydrocarbon group or substituent of 1 to 24 carbon atoms, such as methyl, ethyl, n-propyl, isopropyl, n-butyl, isobutyl, t-butyl, octyl, decyl, tetradecyl, hexadecyl, eicosyl, tetracosyl and the like. In some embodiments, contemplated alkyl groups contain 1 to 12 carbon atoms. The term “cyclic alkyl” means an alkyl compound whose structure is characterized by one or more closed rings. The cyclic alkyl may be mono-, bi-, tri- or polycyclic depending on the number of rings present in the compound. The term “aryl” is used herein to mean a monocyclic aromatic species of 5 to 7 carbon atoms or a compound that is built with monocyclic aromatic species of 5 to 7 carbon atoms and is typically phenyl, naphthalyl, phenanthryl, anthracyl etc. Optionally, these groups are substituted with one to four, more preferably one to two alkyl, alkoxy, hydroxy, and/or nitro substituents.

The term “alkenyl” is used herein to mean a branched or a straight-chain hydrocarbon chain containing from 2 to 24 carbon atoms and at least one double bond. Preferred alkenyl groups herein contain 1 to 12 carbon atoms. The term “alkoxy” is used herein to mean an alkyl group bound through a single, terminal ether linkage; that is, an alkoxy group may be defined as —OR wherein R is an alkyl group, as defined above. The term “arylalkylene” is used herein to mean moieties containing both alkylene and monocyclic aryl species, typically containing less than about 12 carbon atoms in the alkylene portion, and wherein the aryl substituent is bonded to the structure of interest through an alkylene linking group. Exemplary arylalkylene groups have the structure —(CH₂)ⱼ-Ar wherein “j” is an integer in the range of 1 to 6 and wherein “Ar” is an aryl species.

ε-Caprolactam, also known as aminocaproic lactam and 2-oxohexamethyleneimine, is a compound that is produced in flake and molten forms and is used primarily in the manufacture of Nylon-6, Nylon-66 and Nylon-12 products such as those products contemplated herein or other synthetic fibers, plastics, bristles, films, coatings, synthetic leathers, plasticizers and paint vehicles. Caprolactam can also be used as a cross-linking agent for polyurethanes and in the synthesis of the amino acid lysine.

Amides, such as caprolactam, are generally produced by reacting a ketone with hydroxylamine to make an oxime, and then using an acid catalyzed rearrangement of the oxime(s), conventionally called the Beckmann rearrangement, to form the amide. Merchant quality caprolactam can be produced by methods described in U.S. patent application Ser. No.: 10/251335 filed on Sep. 21, 2002, which is commonly owned and herein incorporated in its entirety.

Conventional binder fibers in conventional materials are generally from about 1 weight percent to about 12 weight percent of binder fiber. In embodiments contemplated herein, the plurality of binder fibers is present in the fiber material as a “reduced load”—meaning less than about 2.5 weight percent. In contemplated embodiments, the fiber material may comprise less than about 2.5 weight percent of the plurality of binder fibers. In other contemplated embodiments, the fiber material may comprise less than about 2 weight percent of the plurality of binder fibers. In yet other contemplated embodiments, the fiber material may comprise less than about 1.5 weight percent of the plurality of binder fibers. In additional contemplated embodiments, the fiber material may comprise less than about 1 weight percent of the plurality of binder fibers.

Contemplated yarn counts for the fiber material may range from 1.0/2 ply Ne. to 8.0/2/2 ply Ne. In some embodiments, the yarn counts may be about 1.8/2 ply Ne. In other embodiments, the yarn counts may be about 6/2/2 ply Ne. However, it should be understood that as long as the yarn counts are within the above-stated range, that any suitable yarn count is contemplated.

In addition, methods are provided herein that teach that a fiber material may be produced that includes: a) providing a first base fiber component comprising a first denier and a first luster component; b) providing a second base fiber component comprising a second denier and a second luster component, wherein the first denier and the second denier are different and wherein the first luster component and the second luster component are different; c) providing a plurality of binder fibers; and d) blending the first base fiber component, the second base fiber component and at least some of the plurality of binder fibers to form the fiber material. In additional embodiments, once the first base fiber component, the second base fiber component and the at least some of the plurality of binder fibers are blended, heat is applied to the fiber material to “activate” the binder fibers.

The first base fiber components, the second base fiber components and/or the plurality of binder fibers may be provided by any suitable method, including a) buying the first base fiber components, the second base fiber components and/or the plurality of binder fibers from a supplier or textile mill; b) preparing or producing the first base fiber components, the second base fiber components and/or the plurality of binder fibers in house using chemicals provided by another source and/or c) preparing or producing the first base fiber components, the second base fiber components and/or the plurality of binder fibers in house using chemicals also produced or provided in house or at the location. It is contemplated that the first base fiber components, the second base fiber components and/or the plurality of binder fibers are made of any suitable material, such as those materials already described herein.

The first base fiber component, the second base fiber component and at least some of the plurality of binder fibers can be blended once both the components and the plurality of binder fibers are provided. Blending the first base fiber component, the second base fiber component and at least some of the plurality of binder fibers can be done using any suitable, conventional and/or readily available blending method. It is contemplated that the first base fiber component, the second base fiber component and at least some of the plurality of binder fibers can be blended together at the same time or can be blended together sequentially—meaning that, in some contemplated embodiments, the two base fiber components can be blended together first before the at least some of the plurality of binder fibers is blended with both components or the at least some of the plurality of the binder fibers may be blended with each one of the first base fiber component and the second base fiber component before each is blended with one another.

During or after the formation of contemplated fiber materials, yarn products and/or carpet products, a thermal energy may be applied to the materials and/or products, wherein the thermal energy comprises a temperature that is at or above the melting point of the binder fiber and/or other heat-active components. The thermal energy is applied to activate at least some of the plurality of binder fibers. In some embodiments, activating the binder fibers comprises forming chemical, such as covalent, ionic or hydrogen and/or physical, such as adhesion, bonds between at least some of the plurality of binder fibers and at least one of the first base fiber component or the second base fiber component.

The thermal energy may come from any suitable source, including extended/non-point sources, such as a UV-VIS source, an infra-red source, a heat source, both radiative and convective, or a microwave source; or electron sources, such as electron guns or plasma sources. Other suitable energy sources include electron beams, and radiative devices at non-IR wavelengths including x-ray, and gamma ray. Still other suitable energy sources include vibrational sources such as microwave transmitters. In preferred embodiments, the energy source is an extended source. In more preferred embodiments, the energy source is a heat source, such as an atmospheric pressure forced air machine, which can be followed by a steam purge, or a pressurized twist-setting machine. An example of an atmospheric pressure forced air machine is the Suessen® Twist-Setting Machine, which will activate at least some of the plurality of binder fibers at temperatures ranging from about 195° C. to about 200° C. Examples of pressurized twist-setting machines are those of the autoclave-type and those manufactured by Superba®, which will activate at least some of the plurality of binder fibers at temperatures ranging from about 105° C. to about 138° C.

It should be understood that the thermal energy may be applied consistently or in short bursts. It is also contemplated that the thermal energy may be gradually and continuously applied over a temperature range until the thermal energy is at or above the melting point of the binder fiber or other heat-active components. For example, the fiber material and/or yarn may be heated by an atmospheric pressure forced air machine at a temperature of about 195° C. for a residence time of about 60 seconds, before the treated fiber material and/or yarn product is tufted. The thermal energy may also be immediately applied at or above the melting point of the binder fiber and/or other heat-active components without any ramp time.

The fiber materials contemplated and described herein may be used alone or in combination with other materials and/or products to form any suitable product, including yarn products and carpet products.

### EXAMPLES

The fiber materials, yarn products, carpet products and methods used to produce those materials and products, as described in the examples, are for illustrative purpose only and should not, in any way, limit the scope of this invention.

### Example 1

A blend of the following materials was developed:

50 weight percent of a nylon-6 fiber product that comprises about 1 weight percent of binder fiber, such as T-417—which is manufactured by Honeywell International Inc. This fiber product has a 6.5 denier and a 0.14% TiO₂ luster level.

50 weight percent of a nylon-6 fiber product that comprises zero weight percent of binder fiber, such as T-514—which is manufactured by Honeywell International Inc. This fiber product has a 10 denier and a 0.25% TiO₂ luster level.

This blend was processed by using either an atmospheric pressure forced air machine (Suessen® Twist-Setting Machine), which activates at least some of the plurality of binder fibers at temperatures ranging from about 195° C. to about 200° C., or a pressurized twist-setting machines (the autoclave-type or those manufactured by Superba®), which activates at least some of the plurality of binder fibers at temperatures ranging from about 105° C. to about 138° C.

This blend was also used to produce conventional yarn counts in the range of about 1.0/2 ply Ne to about 8.0/2/2 ply Ne, including 1.8/2 ply Ne and 6/2/2 ply Ne. The yarn bundle has a distinctive appearance and a hand not otherwise realized in a conventional finished yarn or carpet product.

### Example 2

A blend of the following materials can be developed:

40 weight percent of a nylon-6 fiber product that comprises about 1 weight percent of binder fiber, such as T-417—which is manufactured by Honeywell International Inc. This fiber product has a 6.5 denier and a 0.14% TiO₂ luster level.

60 weight percent of a nylon-6 fiber product that comprises zero weight percent of binder fiber, such as T-514—which is manufactured by Honeywell International Inc. This fiber product has a 10 denier and a 0.25% TiO₂ luster level.

This blend was processed by using either an atmospheric pressure forced air machine (Suessen® Twist-Setting Machine), which activates at least some of the plurality of binder fibers at temperatures ranging from about 195° C. to about 200° C., or a pressurized twist-setting machines (the autoclave-type or those manufactured by Superba®), which activates at least some of the plurality of binder fibers at temperatures ranging from about 105° C. to about 138° C.

This blend was also used to produce conventional yarn counts in the range of about 1.0/2 ply Ne to about 8.0/2/2 ply Ne, including 1.8/2 ply Ne and 6/2/2 ply Ne. The yarn bundle has a distinctive appearance and a hand not otherwise realized in a conventional finished yarn or carpet product.

### Example 3

A blend of the following materials can be developed:

60 weight percent of a nylon-6 fiber product that comprises about 1 weight percent of binder fiber, such as T-417—which is manufactured by Honeywell International Inc. This fiber product has a 6.5 denier and a 0.14% TiO₂ luster level.

40 weight percent of a nylon-6 fiber product that comprises zero weight percent of binder fiber, such as T-514—which is manufactured by Honeywell International Inc. This fiber product has a 10 denier and a 0.25% TiO₂ luster level.

This blend was processed by using either an atmospheric pressure forced air machine (Suessen® Twist-Setting Machine), which activates at least some of the plurality of binder fibers at temperatures ranging from about 195° C. to about 200° C., or a pressurized twist-setting machines (the autoclave-type or those manufactured by Superba®), which activates at least some of the plurality of binder fibers at temperatures ranging from about 105° C. to about 138° C.

This blend was also used to produce conventional yarn counts in the range of about 1.0/2 ply Ne to about 8.0/2/2 ply Ne, including 1.8/2 ply Ne and 6/2/2 ply Ne. The yarn bundle has a distinctive appearance and a hand not otherwise realized in a conventional finished yarn or carpet product.

### Example 4

A blend of the following materials can be developed:

35 weight percent of a nylon-6 fiber product that comprises about 1 weight percent of binder fiber, such as T-417—which is manufactured by Honeywell International Inc. This fiber product has a 6.5 denier and a 0.14% TiO₂ luster level.

65 weight percent of a nylon-6 fiber product that comprises zero weight percent of binder fiber, such as T-514—which is manufactured by Honeywell International Inc. This fiber product has a 10 denier and a 0.25% TiO₂ luster level.

This blend was processed by using either an atmospheric pressure forced air machine (Suessen® Twist-Setting Machine), which activates at least some of the plurality of binder fibers at temperatures ranging from about 195° C. to about 200° C., or a pressurized twist-setting machines (the autoclave-type or those manufactured by Superba®), which activates at least some of the plurality of binder fibers at temperatures ranging from about 105° C. to about 138° C.

This blend was also used to produce conventional yarn counts in the range of about 1.0/2 ply Ne to about 8.0/2/2 ply Ne, including 1.8/2 ply Ne and 6/2/2 ply Ne. The yarn bundle has a distinctive appearance and a hand not otherwise realized in a conventional finished yarn or carpet product.

### Example 5

A blend of the following materials can be developed:

65 weight percent of a nylon-6 fiber product that comprises about 1 weight percent of binder fiber, such as T-417—which is manufactured by Honeywell International Inc. This fiber product has a 6.5 denier and a 0.14% TiO₂ luster level.

35 weight percent of a nylon-6 fiber product that comprises zero weight percent of binder fiber, such as T-514—which is manufactured by Honeywell International Inc. This fiber product has a 10 denier and a 0.25% TiO₂ luster level.

This blend was processed by using either an atmospheric pressure forced air machine (Suessen® Twist-Setting Machine), which activates at least some of the plurality of binder fibers at temperatures ranging from about 195° C. to about 200° C., or a pressurized twist-setting machines (the autoclave-type or those manufactured by Superba®), which activates at least some of the plurality of binder fibers at temperatures ranging from about 105° C. to about 138° C.

This blend was also used to produce conventional yarn counts in the range of about 1.0/2 ply Ne to about 8.0/2/2 ply Ne, including 1.8/2 ply Ne and 6/2/2 ply Ne. The yarn bundle has a distinctive appearance and a hand not otherwise realized in a conventional finished yarn or carpet product.

### Example 6

A blend of the following materials was developed:

50 weight percent of a nylon-6 fiber product that comprises about 1.5 weight percent of binder fiber This fiber product has a 6.5 denier and a 0.25% TiO₂ luster level.

50 weight percent of a nylon-6 fiber product that comprises zero weight percent of binder fiber. This fiber product has a 10 denier and a 0.14% TiO₂ luster level.

This blend was processed by using either an atmospheric pressure forced air machine (Suessen® Twist-Setting Machine), which activates at least some of the plurality of binder fibers at temperatures ranging from about 195° C. to about 200° C., or a pressurized twist-setting machines (the autoclave-type or those manufactured by Superba®), which activates at least some of the plurality of binder fibers at temperatures ranging from about 105° C. to about 138° C.

This blend was also used to produce conventional yarn counts in the range of about 1.0/2 ply Ne to about 8.0/2/2 ply Ne, including 1.8/2 ply Ne and 6/2/2 ply Ne. The yarn bundle has a distinctive appearance and a hand not otherwise realized in a conventional finished yarn or carpet product.

### Example 7

A blend of the following materials can be developed:

40 weight percent of a nylon-6 fiber product that comprises about 1.5 weight percent of binder fiber. This fiber product has a 6.5 denier and a 0.25% TiO₂ luster level.

60 weight percent of a nylon-6 fiber product that comprises zero weight percent of binder fiber. This fiber product has a 10 denier and a 0.14% TiO₂ luster level.

This blend was processed by using either an atmospheric pressure forced air machine (Suessen® Twist-Setting Machine), which activates at least some of the plurality of binder fibers at temperatures ranging from about 195° C. to about 200° C., or a pressurized twist-setting machines (the autoclave-type or those manufactured by Superba®), which activates at least some of the plurality of binder fibers at temperatures ranging from about 105° C. to about 138° C.

This blend was also used to produce conventional yarn counts in the range of about 1.0/2 ply Ne to about 8.0/2/2 ply Ne, including 1.8/2 ply Ne and 6/2/2 ply Ne. The yarn bundle has a distinctive appearance and a hand not otherwise realized in a conventional finished yarn or carpet product.

### Example 8

A blend of the following materials can be developed:

60 weight percent of a nylon-6 fiber product that comprises about 1.5 weight percent of binder fiber. This fiber product has a 6.5 denier and a 0.25% TiO₂ luster level.

40 weight percent of a nylon-6 fiber product that comprises zero weight percent of binder fiber. This fiber product has a 10 denier and a 0.14% TiO₂ luster level.

This blend was processed by using either an atmospheric pressure forced air machine (Suessen® Twist-Setting Machine), which activates at least some of the plurality of binder fibers at temperatures ranging from about 195° C. to about 200° C., or a pressurized twist-setting machines (the autoclave-type or those manufactured by Superba®), which activates at least some of the plurality of binder fibers at temperatures ranging from about 105° C. to about 138° C.

This blend was also used to produce conventional yarn counts in the range of about 1.0/2 ply Ne to about 8.0/2/2 ply Ne, including 1.8/2 ply Ne and 6/2/2 ply Ne. The yarn bundle has a distinctive appearance and a hand not otherwise realized in a conventional finished yarn or carpet product.

### Example 9

A blend of the following materials can be developed:

35 weight percent of a nylon-6 fiber product that comprises about 1.5 weight percent of binder fiber. This fiber product has a 6.5 denier and a 0.25% TiO₂ luster level.

65 weight percent of a nylon-6 fiber product that comprises zero weight percent of binder fiber. This fiber product has a 10 denier and a 0.14% TiO₂ luster level.

This blend was processed by using either an atmospheric pressure forced air machine (Suessen® Twist-Setting Machine), which activates at least some of the plurality of binder fibers at temperatures ranging from about 195° C. to about 200° C., or a pressurized twist-setting machines (the autoclave-type or those manufactured by Superba®), which activates at least some of the plurality of binder fibers at temperatures ranging from about 105° C. to about 138° C.

This blend was also used to produce conventional yarn counts in the range of about 1.0/2 ply Ne to about 8.0/2/2 ply Ne, including 1.8/2 ply Ne and 6/2/2 ply Ne. The yarn bundle has a distinctive appearance and a hand not otherwise realized in a conventional finished yarn or carpet product.

### Example 10

A blend of the following materials can be developed:

65 weight percent of a nylon-6 fiber product that comprises about 1.5 weight percent of binder fiber. This fiber product has a 6.5 denier and a 0.25% TiO₂ luster level.

35 weight percent of a nylon-6 fiber product that comprises zero weight percent of binder fiber. This fiber product has a 10 denier and a 0.14% TiO₂ luster level.

This blend was processed by using either an atmospheric pressure forced air machine (Suessen® Twist-Setting Machine), which activates at least some of the plurality of binder fibers at temperatures ranging from about 195° C. to about 200° C., or a pressurized twist-setting machines (the autoclave-type or those manufactured by Superba®), which activates at least some of the plurality of binder fibers at temperatures ranging from about 105° C. to about 138° C.

This blend was also used to produce conventional yarn counts in the range of about 1.0/2 ply Ne to about 8.0/2/2 ply Ne, including 1.8/2 ply Ne and 6/2/2 ply Ne. The yarn bundle has a distinctive appearance and a hand not otherwise realized in a conventional finished yarn or carpet product.

### Example 11

A blend of the following materials was developed:

50 weight percent of a nylon-6 fiber product that comprises about 1.5 weight percent of binder fiber. This fiber product has a 10 denier and a 0.25% TiO₂ luster level.

50 weight percent of a nylon-6 fiber product that comprises zero weight percent of binder fiber. This fiber product has a 6.5 denier and a 0.14% TiO₂ luster level.

This blend was processed by using either an atmospheric pressure forced air machine (Suessen® Twist-Setting Machine), which activates at least some of the plurality of binder fibers at temperatures ranging from about 195° C. to about 200° C., or a pressurized twist-setting machines (the autoclave-type or those manufactured by Superba®), which activates at least some of the plurality of binder fibers at temperatures ranging from about 105° C. to about 138° C.

This blend was also used to produce conventional yarn counts in the range of about 1.0/2 ply Ne to about 8.0/2/2 ply Ne, including 1.8/2 ply Ne and 6/2/2 ply Ne. The yarn bundle has a distinctive appearance and a hand not otherwise realized in a conventional finished yarn or carpet product.

### Example 12

A blend of the following materials can be developed:

40 weight percent of a nylon-6 fiber product that comprises about 1.5 weight percent of binder fiber. This fiber product has a 10 denier and a 0.25% TiO₂ luster level.

60 weight percent of a nylon-6 fiber product that comprises zero weight percent of binder fiber. This fiber product has a 6.5 denier and a 0.14% TiO₂ luster level.

This blend was processed by using either an atmospheric pressure forced air machine (Suessen® Twist-Setting Machine), which activates at least some of the plurality of binder fibers at temperatures ranging from about 195° C. to about 200° C., or a pressurized twist-setting machines (the autoclave-type or those manufactured by Superba®), which activates at least some of the plurality of binder fibers at temperatures ranging from about 105° C. to about 138° C.

This blend was also used to produce conventional yarn counts in the range of about 1.0/2 ply Ne to about 8.0/2/2 ply Ne, including 1.8/2 ply Ne and 6/2/2 ply Ne. The yarn bundle has a distinctive appearance and a hand not otherwise realized in a conventional finished yarn or carpet product.

### Example 13

A blend of the following materials can be developed:

60 weight percent of a nylon-6 fiber product that comprises about 1.5 weight percent of binder fiber. This fiber product has a 10 denier and a 0.25% TiO₂ luster level.

40 weight percent of a nylon-6 fiber product that comprises zero weight percent of binder fiber. This fiber product has a 6.5 denier and a 0.14% TiO₂ luster level.

This blend was processed by using either an atmospheric pressure forced air machine (Suessen® Twist-Setting Machine), which activates at least some of the plurality of binder fibers at temperatures ranging from about 195° C. to about 200° C., or a pressurized twist-setting machines (the autoclave-type or those manufactured by Superba®), which activates at least some of the plurality of binder fibers at temperatures ranging from about 105° C. to about 138° C.

This blend was also used to produce conventional yarn counts in the range of about 1.0/2 ply Ne to about 8.0/2/2 ply Ne, including 1.8/2 ply Ne and 6/2/2 ply Ne. The yarn bundle has a distinctive appearance and a hand not otherwise realized in a conventional finished yarn or carpet product.

### Example 14

A blend of the following materials can be developed:

35 weight percent of a nylon-6 fiber product that comprises about 1.5 weight percent of binder fiber. This fiber product has a 10 denier and a 0.25% TiO₂ luster level.

65 weight percent of a nylon-6 fiber product that comprises zero weight percent of binder fiber. This fiber product has a 6.5 denier and a 0.14% TiO₂ luster level.

This blend was processed by using either an atmospheric pressure forced air machine (Suessen® Twist-Setting Machine), which activates at least some of the plurality of binder fibers at temperatures ranging from about 195° C. to about 200° C., or a pressurized twist-setting machines (the autoclave-type or those manufactured by Superba®), which activates at least some of the plurality of binder fibers at temperatures ranging from about 105° C. to about 138° C.

This blend was also used to produce conventional yarn counts in the range of about 1.0/2 ply Ne to about 8.0/2/2 ply Ne, including 1.8/2 ply Ne and 6/2/2 ply Ne. The yarn bundle has a distinctive appearance and a hand not otherwise realized in a conventional finished yarn or carpet product.

### Example 15

A blend of the following materials can be developed:

65 weight percent of a nylon-6 fiber product that comprises about 1.5 weight percent of binder fiber. This fiber product has a 10 denier and a 0.25% TiO₂ luster level.

35 weight percent of a nylon-6 fiber product that comprises zero weight percent of binder fiber. This fiber product has a 6.5 denier and a 0.14% TiO₂ luster level.

This blend was processed by using either an atmospheric pressure forced air machine (Suessen® Twist-Setting Machine), which activates at least some of the plurality of binder fibers at temperatures ranging from about 195° C. to about 200° C., or a pressurized twist-setting machines (the autoclave-type or those manufactured by Superba®), which activates at least some of the plurality of binder fibers at temperatures ranging from about 105° C. to about 138° C.

This blend was also used to produce conventional yarn counts in the range of about 1.0/2 ply Ne to about 8.0/2/2 ply Ne, including 1.8/2 ply Ne and 6/2/2 ply Ne. The yarn bundle has a distinctive appearance and a hand not otherwise realized in a conventional finished yarn or carpet product.

We claim:

1. A fiber material, comprising:
a first base fiber component comprising a first denier and a first luster component;
a second base fiber component comprising a second denier and a second luster component, wherein the first denier and the second denier are different and wherein the first luster component and the second luster component are different; and
a plurality of binder fibers.

2. The fiber material of claim 1, wherein at least some of the binder fibers comprises a synthetic material.

3. The fiber material of claim 2, wherein the synthetic material comprises a polyamide-based compound.

4. The fiber material of claim 3, wherein the polyamide-based compound comprises nylon-6.

5. The fiber material of claim 3, wherein the polyamide-based compound comprises nylon-6,6.

6. The fiber material of claim 3, wherein the polyamide-based compound comprises nylon-12.

7. The fiber material of claim 1, wherein the fiber material comprises less than about 2.5 weight percent of the plurality of binder fibers.

8. The fiber material of claim 7, wherein the fiber material comprises less than about 2 weight percent of the plurality of binder fibers.

9. The fiber material of claim 8, wherein the fiber material comprises less than about 1.5 weight percent of the plurality of binder fibers.

10. The fiber material of claim 9, wherein the fiber material comprises less than about 1 weight percent of the plurality of binder fibers.

11. The fiber material of claim 1, wherein the first luster component is less than about 0.45% TiO₂.

12. The fiber material of claim 11, wherein the first luster component is less than about 0.25% TiO₂.

13. The fiber material of claim 12, wherein the first luster component is less than about 0.15% TiO₂.

14. The fiber material of claim 13, wherein the first luster component is less than about 0.1% TiO₂.

15. The fiber material of claim 1, wherein the second luster component is less than about 0.45% TiO₂.

16. The fiber material of claim 15, wherein the second luster component is less than about 0.25% TiO₂.

17. The fiber material of claim 16, wherein the second luster component is less than about 0.15% TiO₂.

18. The fiber material of claim 17, wherein the second luster component is less than about 0.1% TiO₂.

19. The fiber material of claim 1, wherein the first denier is from about 6 to about 12.

20. The fiber material of claim 1, wherein the second denier is from about 6 to about 12.

21. The fiber material of claim 19, wherein the first denier is less than about 12.

22. The fiber material of claim 21, wherein the first denier is less than about 7.

23. The fiber material of claim 22, wherein the first denier is 6.5.

24. The fiber material of claim 20, wherein the second denier is less than about 12.

25. The fiber material of claim 24, wherein the second denier is 10.

26. The fiber material of claim 24, wherein the second denier is less than about 7.

27. A method of producing a fiber material, comprising:
providing a first base fiber component comprising a first denier and a first luster component;
providing a second base fiber component comprising a second denier and a second luster component, wherein the first denier and the second denier are different and wherein the first luster component and the second luster component are different;
providing a plurality of binder fibers; and
blending the first base fiber component, the second base fiber component and at least some of the plurality of binder fibers to form the fiber material.

28. The method of claim 27, wherein the binder fiber comprises a synthetic material.

29. The method of claim 28, wherein the synthetic material comprises a polyamide-based compound.

30. The method of claim 29, wherein the polyamide-based compound comprises nylon-6.

31. The method of claim 29, wherein the polyamide-based compound comprises nylon-6,6.

32. The method of claim 29, wherein the polyamide-based compound comprises nylon-12.

33. The method of claim 27, wherein the fiber material comprises less than about 2.5 weight percent of the plurality of binder fibers.

34. The method of claim 33, wherein the fiber material comprises less than about 2 weight percent of the plurality of binder fibers.

35. The method of claim 34, wherein the fiber material comprises less than about 1.5 weight percent of the plurality of binder fibers.

36. The method of claim 35, wherein the fiber material comprises less than about 1 weight percent of the plurality of binder fibers.

37. The method of claim 27, wherein the first luster component is less than about 0.45% TiO₂.

38. The method of claim 37, wherein the first luster component is less than about 0.25% TiO₂.

39. The method of claim 38, wherein the first luster component is less than about 0.15% TiO₂.

40. The method of claim 39, wherein the first luster component is less than about 0.1% TiO₂.

41. The method of claim 27, wherein the second luster component is less than about 0.45% TiO₂.

42. The method of claim 41, wherein the second luster component is less than about 0.25% TiO₂.

43. The method of claim 42, wherein the second luster component is less than about 0.15% TiO₂.

44. The method of claim 43, wherein the second luster component is less than about 0.1% TiO₂.

45. The method of claim 27, wherein the first denier is from about 6 to about 12.

46. The method of claim 27, wherein the second denier is from about 6 to about 12.

47. The method of claim 45, wherein the first denier is less than about 12.

48. The method of claim 47, wherein the first denier is less than about 7.

49. The method of claim 48, wherein the first denier is 6.5.

50. The method of claim 46, wherein the second denier is less than about 12.

51. The method of claim 50, wherein the second denier is 10.

52. The method of claim 50, wherein the second denier is less than about 7.

53. The method of claim 27, wherein blending further comprises heating the first base fiber component, the second base fiber component and at least some of the plurality of binder fibers to activate the binder fibers.

54. The method of claim 53, wherein activating the binder fibers comprises forming bonds between the plurality of binder fibers and at least one of the first base fiber component and the second base fiber component.

55. The method of claim 53, wherein heating comprises atmospheric pressure forced air heating.

56. The method of claim 53, wherein heating comprises pressurized steam heating.

57. A yarn product comprising the fiber material of claim 1.

58. A carpet product comprising the fiber material of claim 1.

59. A carpet product comprising the yarn product of claim 57.
